(19) United States
(12) Patent Application Publication
(10) Pub. No.: US 2009/0319285 A1
(43) Pub. Date: Dec. 24, 2009

(54) TECHNIQUES FOR MANAGING DISRUPTIVE BUSINESS EVENTS

(75) Inventors: John D. Fan, Duvall, WA (US); Dustin G. Friesenhahn, Bellevue, WA (US); Adam Harmetz, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/142,804

(22) Filed: Jun. 20, 2008

(51) Int. Cl. G06Q 10/00

(52) U.S. Cl. 705/1

(57) ABSTRACT

Various technologies and techniques are disclosed for managing disruptive business events. A selection is received from a user to associate one or more items in a content repository with one or more disruptive business events. Once items are associated with events, the business processes around those items change based upon predefined event settings defined on the business events. As users interact with the one or more items associated with the disruptive business event during a normal course of business, one or more actions associated with the event settings are applied. Items associated with disruptive business events can be assigned at different levels in a hierarchy in the content repository. Other applications can retrieve data regarding the disruptive business events.

### BACKGROUND

Most content that is created by companies today typically gets stored in an electronic form. In many cases, the electronic version of a particular document or other content may be the only format in which the information exists. In a typical business cycle, such content gets created, used, and then destroyed once it is no longer needed. This destruction of electronic content can either happen according to a pre-defined schedule (e.g. an expiration policy), or the destruction can happen manually when a user deletes files he doesn't need any more.

Business events can sometimes occur that will disrupt this natural cycle of a piece of content. For example, a company audit, lawsuit, or investigation are all examples of disruptive business events where certain pieces of content need to be tagged as related to an investigation and the business processes changed accordingly. The process of finding content related to such an event is often called “discovery” and the process of locking down items related to an event is often called “hold.”

As the amount of content that is subject to this discovery process grows, the management of disruptive business events grows increasingly more complex. Each disruptive business event might be managed by a different individual; documents associated with a particular disruptive business event may span different repositories; and so on.

### SUMMARY

Various technologies and techniques are disclosed for managing disruptive business events. A selection is received from a user to associate one or more items in a content repository with one or more disruptive business events. Once items are associated with events, the business processes around those items change based upon predefined settings defined on the business events. As users interact with the one or more items associated with the disruptive business event during a normal course of business, one or more actions associated with the event settings are applied.

In one implementation, a system for managing one or more disruptive business events across one or more content repositories is described. The system includes one or more content repositories for storing items of content. The system includes one or more lists of disruptive business events that have been created in one or more content repositories. Events in a list can then be associated with at least a sub-set of the items in the repository where the list was created. The one or more content repositories control the management of the disruptive business events and the associated sub-set of the items of content to ensure that any actions associated with the sub-set of the items through the events lists are applied as users interact with the sub-set of the items.

In another implementation, a method for sharing data for one or more disruptive business events with other applications is described. A request is received from a separate application to access data and settings for a disruptive business event that has been associated with a sub-set of items in a content repository. The data that was requested by the separate application is retrieved and then returned to the separate application.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a system for managing disruptive business events.

FIG. 2 is a process flow diagram for one implementation illustrating the stages involved in associating items with disruptive business events.

FIG. 3 is a diagrammatic view for one implementation illustrating items associated with disruptive business events at different levels in a hierarchy.

FIG. 4 is a process flow diagram for one implementation illustrating the stages involved in generating a list of items that can be associated with a disruptive business event.

FIG. 5 is a process flow diagram for one implementation illustrating the stages involved in allowing a user to export items to a records vault.

FIG. 6 is a process flow diagram for one implementation illustrating the stages involved in tracking data as searches are performed against items associated with a disruptive business event.

FIG. 7 is a process flow diagram for one implementation that illustrates the stages involved in sharing data regarding disruptive business events with other applications.

FIG. 8 is a diagrammatic view of a computer system of one implementation.

### DETAILED DESCRIPTION

The technologies and techniques herein may be described in the general context as an application that manages disruptive business events for one or more content repositories, but the technologies and techniques also serve other purposes in addition to these. In one implementation, one or more of the techniques described herein can be implemented as features within a content repository such as MICROSOFT® Office SharePoint Server, or from any other type of program or service that is responsible for managing electronic content that may be subject to disruptive business events such as lawsuits or audits.

In one implementation, techniques are described for management of disruptive business events and a related discovery process. The term “disruptive business event” as used herein is meant to include an event that disrupts the normal flow of a business process such that electronic content needs to be managed in a different manner, such as to have different behavior and/or actions taken when interacting with content. As noted earlier, a few examples of disruptive business events can include lawsuits, audits, investigations, etc. Some or all of the techniques described herein allow a disruptive business event and the electronic documents to which it relates to be associated with a disruptive business event in an events list and organized in a hierarchal manner. The term “events list” as used herein is meant to include a list of one or more disruptive business event that have been or can be associated with one or more items in one or more content repositories. Alternatively or additionally, techniques are described for customizing what happens when an item has been associated with a particular disruptive business event in an events list, and/or for enabling data related to the disruptive business events to be shared with other systems.

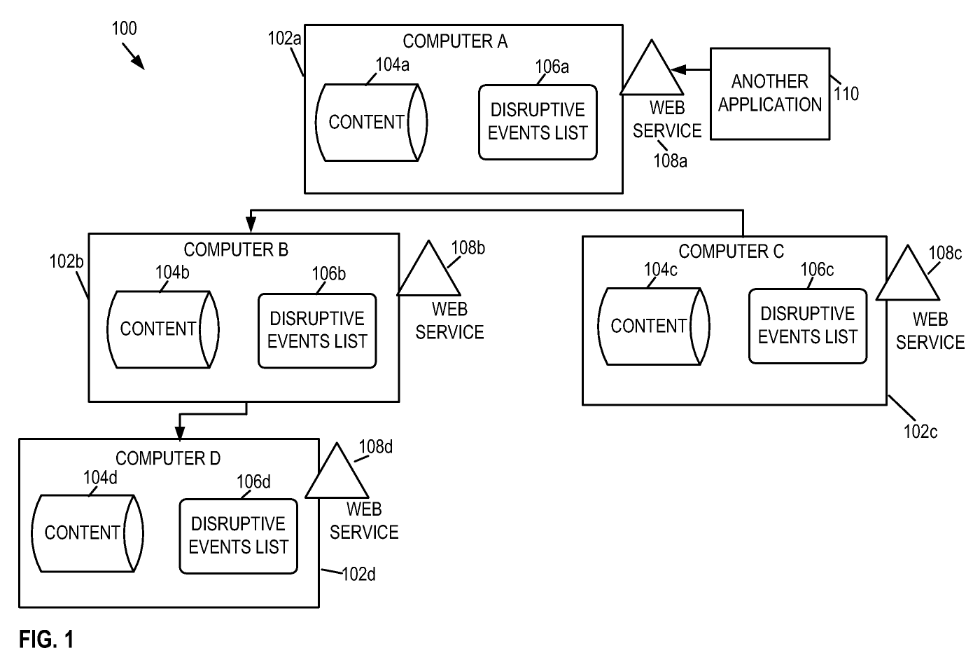

FIG. 1 is a diagrammatic view of a system 100 for managing disruptive business events in one or more events lists. As described earlier, a disruptive business event that has been set up for a content repository is added to an events list so that users can later associate items in the content repositories with the disruptive business event(s). System 100 contains multiple computers (102a, 102b, 102c, and 102d). In the example shown in FIG. 1, each of these computers (102a, 102b, 102c, and 102d) includes a content repository (104a, 104b, 104c, and 104d) as well as an events list (106a, 106b, 106c, and 106d). An events list (102a, 102b, 102c, and 102d) can be created in a content repository (104a, 104b, 104c, and 104d) and/or otherwise associated with a content repository. In other implementations, it will be appreciated that fewer or additional content repositories may be shown, and/or that fewer or additional events lists may be shown. For example, there can be fewer events lists than there are content repositories. As one non-limiting example of such a structure, there may be only one events list in a root content repository that applies to all sub-content repositories. Furthermore, there can be fewer or additional computers than those shown in FIG. 1. The structure shown in FIG. 1 is just for the sake of illustration, and numerous other variations are also possible.

Content repository (104a, 104b, 104c, or 104d) is responsible for storing and managing items. The term “item” as used herein is meant to include a document, spreadsheet, web page, wiki, blog, or any other type of electronic content that is being managed by the content repository. The events list (106a, 106b, 106c, or 106d) can contain information about one or more disruptive business events that have been defined for the company using the content repository. Using system 100, events lists can be defined and managed so that these disruptive business events can be integrated into the normal process of content creation and maintenance, yet managed according to any legal or other requirements that have been defined for them.

Events lists (106a, 106b, 106c, and 106d) can contain disruptive business events that are be associated with items in the content repositories in a hierarchical fashion. In other words, content inside a content repository can be structured in a hierarchical manner. For example, sites can contain sub-sites which contain libraries which contain folders, which contain items. Disruptive business events can be defined at multiple levels in that hierarchy. Content within the repository can be subject to any disruptive business event defined in its parent chain. Some non-limiting examples will be described to further illustrate how system 100 can be used in one implementation.

Suppose Contoso Corporation is a company that is using computers (102a, 102b, 102c, and 102d) for storing various content, as shown in FIG. 1. Further suppose that Contoso has a large number of electronic documents. As a large company, suppose that Contoso tends to be involved in ongoing complex litigations and that they have a legal obligation to find content related to each case.

Further suppose that their repository of content is structured so that their consumer products division is separated from their business division. Thus, computers 102a and 102b with content repositories 104a and 104b may be used by the products division, and computers 102c and 102d with content repositories 104c and 104d may be used by their business division, just as an example. System 100 allows any of Contoso's disruptive business events that involve the entire company to be defined and managed at the root level, and used throughout the entire repository. However, disruptive business events that impact only a single division can be defined within the division's repository, and their use will be appropriately scoped to the division's repository.

In addition, suppose that Contoso's repository has different types of content—for instance, word processing documents and web pages. System 100 allows customizations to be made to control what happens when an item is subject to a case. For instance, documents can be exported to a records vault while web pages can be locked down and editing prevented.

Alternatively or additionally, Contoso employees may have gone through a large amount of effort defining data about disruptive business events and performing searches for content within a repository. In one implementation, web services (such as 108a, 108b, 108c, or 108d) allow the company (in this example, Contoso) to share information about the disruptive business events (in this example, the lawsuits) with other applications or content repositories, such as an email server.

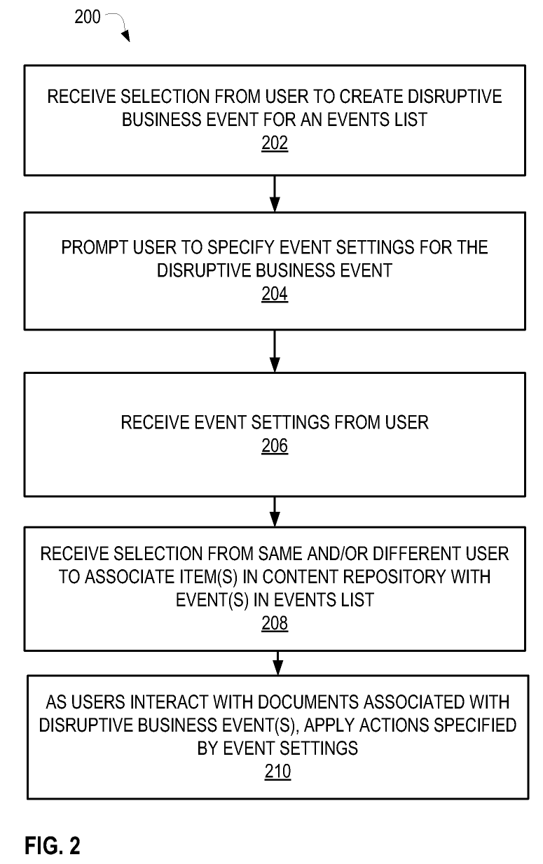

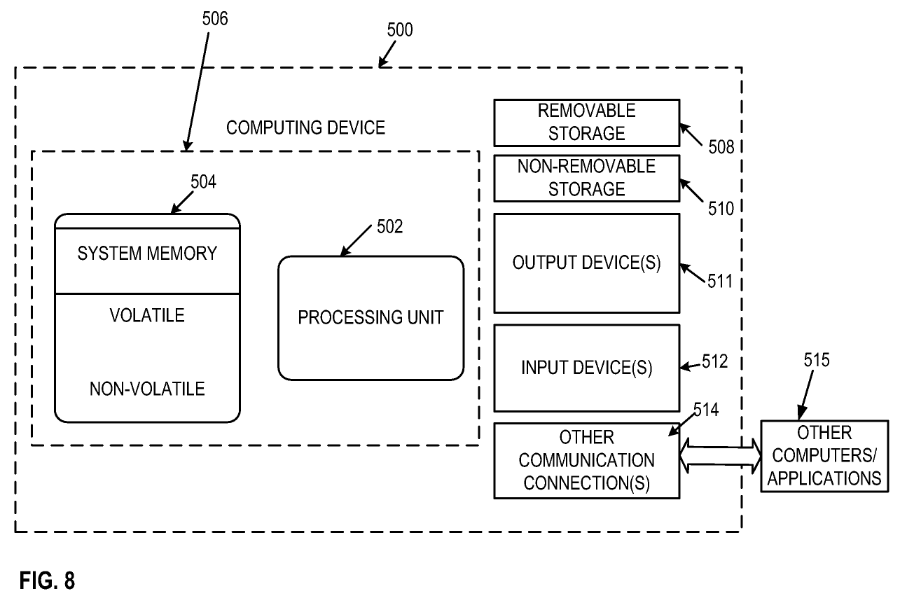

Turning now to FIGS. 2-7, the stages for implementing one or more implementations of system 100 for managing events lists are described in further detail. In some implementations, the processes of FIG. 2-7 are at least partially implemented in the operating logic of computing device 500 (of FIG. 8).

FIG. 2 is a process flow diagram 200 for one implementation illustrating the stages involved in associating items with disruptive business events and managing the items. A user is provided with an option to add a disruptive business event to an events list for a company (stage 202). The user is then prompted to specify event settings for the items (stage 204). “Event settings” are options that indicate what should happen to one or more items that are associated with the disruptive business event to which the event settings are applied. Event settings can define what should happen to the one or more items over a period of time, such as how business processes are impacted that change how the content is managed over time. Some examples of event settings can include, but are not limited to, suspending the disposition of an item, blocking the deletion of the item or its containers, preventing the editing of the item, sending the item to a records vault, or running a custom extension that can execute custom logic. In this manner, users can configure what happens when an item is associated with an event. The event settings are then received from the user and stored for later use in managing the items (stage 206). Event settings can be defined on a per event basis, based upon the content repository the item is in, etc.

A selection is received from the same and/or different users to associate one or more items in one or more content repositories with one or more disruptive business events contained in the events list (stage 208). For example, the user can select one or more items that should be associated with a particular disruptive business event, such as a lawsuit or audit. This association of items with the disruptive business event can be performed at some later time after the disruptive business event and its event settings have been created.

As users interact with the items associated with the disruptive business event, actions are applied and the item's state is changed according to the event settings (stage 210). Some example actions can include logging changes that are made to the item, logging access details about who opened the item, logging a user name of a particular person who accessed the item, saving search metadata that describe a search that was used to locate the item, etc.

In one implementation, event settings can be defined at any point in this process of FIG. 2, such as to refine the event settings over a period of time. Thus, the stages can happen in a different order than described in FIG. 2 as the users interact with the content repository to manage and/or access items that have been associated with disruptive business events.

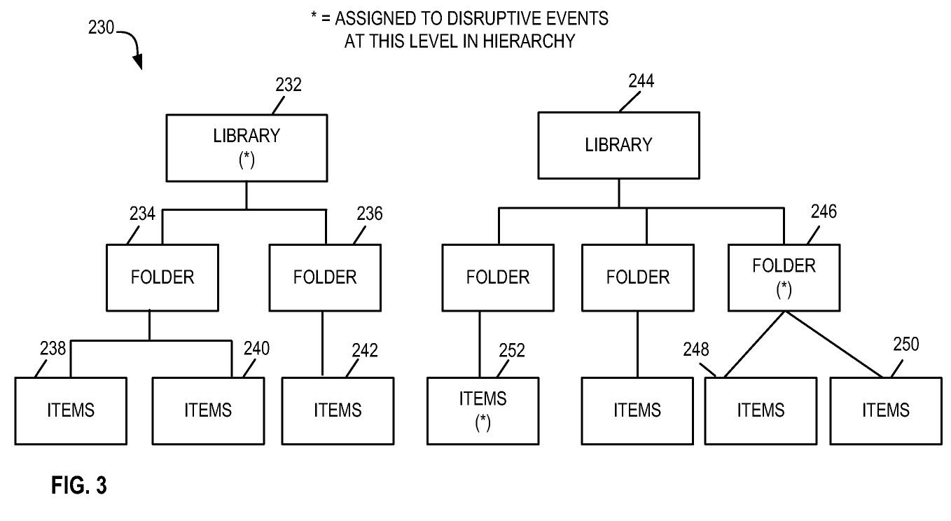

FIG. 3 is a diagrammatic view 230 for one implementation illustrating a hierarchical set of events lists. As described earlier in FIG. 1, events lists can be associated with items in a hierarchical fashion, just as content repositories can be hierarchical. Each instance of a content repository can have its own events list. Any items that are included in the parent chain of a given content repository can be associated with the events list. In other words, an entire content repository can be associated with an events list, or just a sub-set of the items in the content repository can be associated with one or more disruptive business events that are related to the events list.

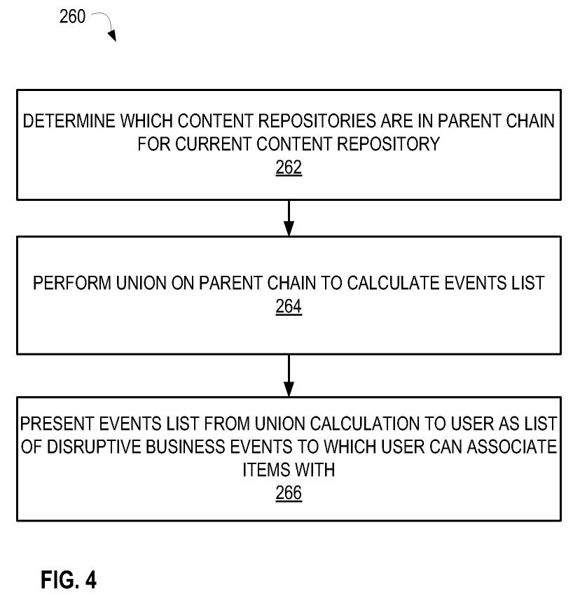

For example, diagram 230 shows two different content repositories. Library 232 has its own hierarchy, and library 244 has its own hierarchy. If the entire library 232 is associated with a disruptive business event, then all of the items in that library become subject to any actions associated with the disruptive business event. This includes all of the folders (234 and 236), and all of the items (238, 240, and 242). If instead of associating an entire library with one or more disruptive business events in an events list, a particular folder is added (such as folder 246). Then any items that belong to that folder are subject to the disruptive business event (which is items 248 and 250) in this example. At the most granular level, a single item can also be associated with a disruptive business event (such as item 252). By allowing items to be associated with events lists in a hierarchical fashion, organizations can manage disruptive business events at multiple levels of content and federate the management of events. Alternatively or additionally, organizations can manage items (i.e. documents) more easily without having to assign each item one by one to a particular disruptive business event. FIG. 4 describes a process for generating events list(s) to which items can be associated based upon a hierarchical list.

FIG. 4 is a process flow diagram 260 for one implementation illustrating the stages involved in generating a list of disruptive business events applicable to a given content repository. The content repositories that are in the parent chain for the current content repository are determined (stage 262). A union is performed on the parent chain to calculate the events lists that can be used (stage 264). The events lists that are generated from the union calculation are presented to the user as the list of disruptive business events to which the user can associate items with (stage 266).

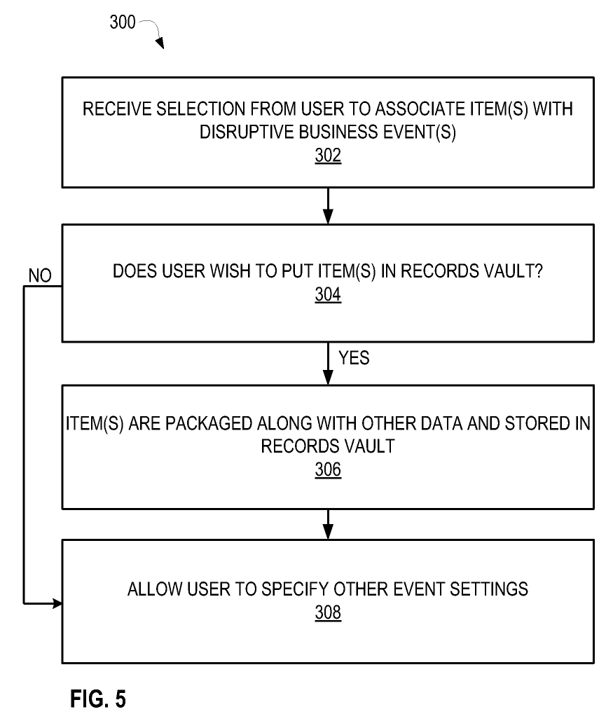

FIG. 5 is a process flow diagram 300 for one implementation illustrating the stages involved in allowing a user to export items to a records vault. A selection is received from a user to associate one or more items with one or more disruptive business events in an events list (stage 302). If the user selects an option to put one or more items in a records vault (i.e. an external repository that has additional restrictions) (decision point 304), then the items are packaged along with other data and stored in the records vault (stage 306). In one implementation, the entire context of a record, such as its properties and audit log, are preserved and sent along with the item itself. The records vault ensures that the item(s) cannot be deleted and/or modified. In other words, instead of locking down the item(s) in place, users can export relevant content out of its native repository and place it in a locked down repository. The user can specify other event settings as desired (stage 308). For example, the user can specify various event settings that can apply to the items that have been added to the records vault. A few non-limiting examples include a setting that indicates that the item(s) cannot be deleted, a setting that indicates that any accesses to the item(s) should be audited (logged), etc.

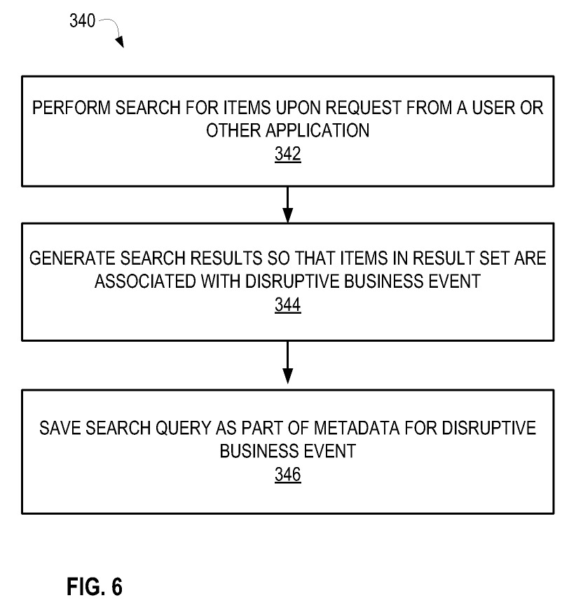

FIG. 6 is a process flow diagram 340 for one implementation illustrating the stages involved in tracking data such as searches that are performed to find items that should be associated with a disruptive business event. A search is performed for items in a content repository upon request from a user or other application (stage 342). The search results are generated so that all items in the result set are associated with the disruptive business event (stage 344). The search query is saved as part of the metadata for the disruptive business event (stage 346). In other words, details get logged about the search criteria that were used to find the document, who performed the search, etc.

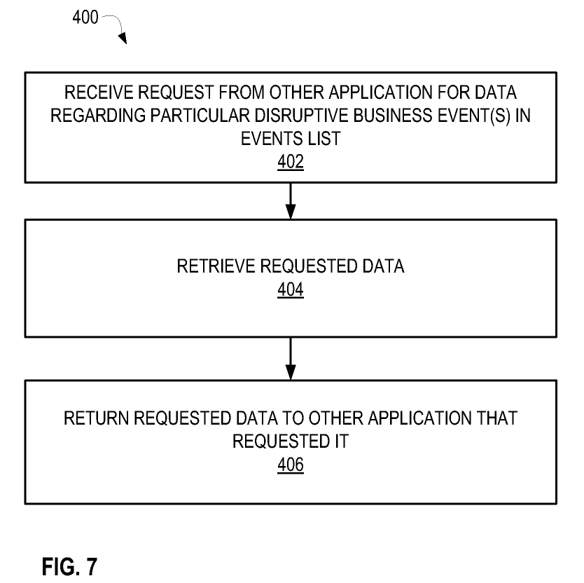

FIG. 7 is a process flow diagram 400 for one implementation that illustrates the stages involved in sharing data for one or more disruptive business events with other applications. A request is received from a separate application to access data related to one or more disruptive business events in an events list (stage 402), such as through a web service, as described in further detail in FIG. 1. For example, the requested data can be regarding a sub-set of items in a content repository that were associated with a disruptive business event. The requested data is retrieved for the disruptive business event(s) (stage 404). The requested data is returned to the separate application that requested it (stage 406). For example, the other application may also be subject to a disruptive business event and may wish to query the disruptive business event and associated data store for data so that the effort that has already been expended in adding data for the disruptive business event can be utilized. As a non-limiting example, the other application may wish to perform the same searches on its content that were performed in the source application.

As shown in FIG. 8, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 8 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 8 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for adding and managing items associated with a disruptive business event comprising the steps of:
receiving a selection from a user to associate one or more items in a content repository with a disruptive business event defined in an events list, the disruptive business event having event settings that have been defined; and
as users interact with the one or more items associated with the disruptive business event during a normal course of business, apply one or more actions associated with the event settings.

2. The method of claim 1, wherein the one or more actions include logging changes that are made to the one or more items.

3. The method of claim 1, wherein the one or more actions include logging access details about the one or more items.

4. The method of claim 3, wherein the access details include a user name of a particular person accessing the one or more items.

5. The method of claim 1, wherein the one or more actions include saving search metadata to describe a search that was used to locate the one or more items.

6. The method of claim 1, wherein the events list is selected from a plurality of events lists that are part of a hierarchy of content repositories.

7. The method of claim 1, wherein the event settings include a request to add the one or more items to a records vault.

8. The method of claim 7, wherein the event settings can be applied to the one or more items in the records vault.

9. The method of claim 1, wherein the event settings include a setting used to ensure that the one or more items cannot be deleted.

10. The method of claim 1, wherein the event settings include a setting used to ensure that changes to the one or more items are audited.

11. A system for managing one or more disruptive business events for one or more content repositories comprising:
one or more content repositories for storing items of content;
one or more disruptive business events that have been associated with at least a sub-set of the items of content; and
wherein the one or more content repositories are operable to control management of the disruptive business events and the associated sub-set of the items of content to ensure that any actions associated with the sub-set of the items through the disruptive business events are applied as users interact with the sub-set of the items.

12. The system of claim 11, wherein at least one of the disruptive business events has been assigned to a particular lawsuit.

13. The system of claim 11, wherein at least one of the disruptive business events has been assigned to a particular audit.

14. The system of claim 11, wherein any item in the content repository can be associated with the one or more disruptive business events that are part of a parent chain of the content repository.

15. The system of claim 11, wherein the actions associated with the sub-set of items can include logging changes that are made to a particular one of the sub-set of items.

16. The system of claim 11, wherein the actions associated with the sub-set of items can include logging search metadata that is used to locate a particular one of the sub-set of items.

17. The system of claim 11, wherein the one or more disruptive business events are defined for items related to different levels in an organizational hierarchy in the content repository.

18. A method for sharing data for disruptive business events with other applications comprising the steps of:
receiving a request from a separate application to access data for a disruptive business event that has been associated with a sub-set of items in a content repository;
retrieving the data that was requested from the separate application; and
returning the data that was requested to the separate application.

19. The method of claim 18, wherein the request is received from the separate application through a web service.

20. The method of claim 19, wherein the data is returned to the separate application through the web service.
